(19) United States
(12) Patent Application Publication
(10) Pub. No.: US 2006/0032465 A1
(43) Pub. Date: Feb. 16, 2006

(54) Methods and apparatus for collecting animal waste

(76) Inventor: Holly L. Valliant, Vista, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/185,341

(22) Filed: Jul. 20, 2005

Related U.S. Application Data
(60) Provisional application No. 60/590,208, filed on Jul. 21, 2004.

(51) Int. Cl. A01K 23/00

(52) U.S. Cl. 119/867

(57) ABSTRACT

Embodiments of the invention relate generally to improved apparatus and methods for the containment of animal waste, particularly pet waste. Some embodiments relate to methods of intercepting pet waste. Other embodiments relate to pet waste containment apparatus. Still further embodiments relate to apparatus for intercepting animal waste.

### CROSS REFERENCE TO RELATED APPLICATIONS

This applications claims priority under 35 U.S.C. 119(e) to and is a non-provisional of U.S. Provisional Application No. 60/590,208, filed on Jul. 21, 2004, entitled METHODS AND APPARATUS FOR COLLECTING ANIMAL WASTE, which is hereby incorporated by reference in its entirety.

### BACKGROUND OF THE INVENTION

1. Field of the Invention

Embodiments of the invention relate generally to improved apparatus and methods for the containment of animal waste, particularly pet waste.

2. Description of the Related Art

Collection and clean-up of animal waste, particularly from pets such as dogs, is an ongoing problem. Pet waste, from dogs for example, is a nuisance, but also presents health and safety concerns. Many states, cities and municipalities have enacted laws and ordinances aimed at curbing problems related to animal waste.

Also, many non governmental attempts have been made to develop solutions to the problem. Attempted solutions generally have included bags, gloves, scooping devices, pads, poles with bags, animal diapers, etc.

Some exemplary publications disclosing previously attempted methods and devices include, for example, U.S. Pat. Nos. 3,626,900; 4,156,400; 4,646,685; 4,800,677; 4,872,420; 5,115,766; 5,178,426; 5,222,777; 5,476,067; 5,522,628; 5,779,290; 6,273,481; 6,471,267; 6,648,387; U.S. Application Publication Nos. 2002/0096895; 2002/0023850; 2002/0140240; French Application Publication No. FR002562384A1; and European Patent Application Publication No. 0250815A1. Unfortunately, the previous approaches have proven largely unsuccessful as animal waste continues to be a significant problem.

Most animal owners wait for their animal to defecate on the ground before the owner then collects the waste. The collection is typically done using a glove, a bag, a box or some other sort of scooping device. Many times some of the animal waste will still remain on the ground unless water is available to completely cleanse the area contacted by the waste. A further drawback associated with the gloves and bags is that the owner is required to grasp and handle the waste. A problem with the scoopers is that they requiring cleaning and they may not be designed to be carried with the owner during walks or exercise activity.

Other attempts to solve the problem have included devices such as flat pads and sheets designed to lie flat on the ground under the animal. These devices require that the animal position itself properly on top of the device, or that the waste does not miss or tumble off of the device.

Others have designed litter boxes for animal waste, including single use or disposable boxes. However, such boxes are not conveniently usable for owners who exercise or walk with their animals because such devices are cumbersome to carry or transport.

Diapers represent another approach that has been attempted to solve the animal waste problem. The diapers are unsatisfactory for various reasons, include it is difficult to put them onto or to take them off of the animals. Furthermore, even if an owner is able to use them on his/her respective animal, waste is still left on the animal which means the animal will require cleaning or bathing after each use.

Thus, previous attempts to solve the problem have remained unsatisfactory for many owners. The instant embodiments relate to apparatus and methods that overcome many of the unsolved problems.

### SUMMARY OF THE INVENTION

Some embodiments relate to methods of intercepting pet waste. The methods can include providing a self-supporting containment apparatus having a size that permits the containment apparatus to fit under the pet's hind section while the pet is defecating, and having a size sufficient to contain an entirety of waste released from the pet; positioning the containment apparatus under the hind section of the pet, such that the released pet waste is intercepted by the apparatus; and closing the containment apparatus. The containment apparatus can include, for example, a base, one or more side members connected to the base at an angle, and a closing member connected to the one or more side members which is utilized as part of closing the containment apparatus. The angle can be, for example, about 90, 100, 110, 120, 130, 135, 140, or 150 degrees. The side members can be in a retracted or an extended position prior to defecation by the pet. The side members can be in an extended position after defecation by the pet. The positioning step can include supporting the containment apparatus when the pet is in the process of defecating. The supporting can include placing the apparatus on the ground or placing the apparatus between the ground and the hind portion of the pet, for example. Preferably, the pet is a dog.

Other embodiments relate to pet waste containment apparatus. The apparatus can include, for example, a base; one or more side members connected to the base at an angle of at least about 90 degrees to not more than about 150 degrees; and a closing member. The side members can have a height sufficient to prevent spillage of pet waste. The base and one or more side members can include a water resistant material. The base and one or more side members further can include an absorbent material on the interior of the apparatus.

Still further embodiments relate to apparatus for intercepting animal waste. The apparatus can include a self-supporting enclosure adapted for receiving animal waste. The self-supporting enclosure can include, for example, a base having a periphery; one or more side members extending outward from the periphery of the base and defining an opening for receiving the animal waste, the one or more side members being capable of motion between a retracted position having a shorter length and an extended position having a greater length than the retracted position; and a closing member joined to the one or more side members, the closing member being adapted for sealing the one or more side members together to close the opening. The one or more side members can be integral with the base. The base and side members can be formed from a bag.

### BRIEF DESCRIPTION OF THE DRAWINGS

FIGS. 1A-C depict various configurations of one exemplary embodiment of the apparatus having a paper covered wire closure mechanism.

FIGS. 2A-C depict various configurations of another exemplary embodiment of the apparatus having a string closure mechanism.

FIGS. 3A-D depict top views of various apparatus embodiments having different shapes.

FIGS. 4A-C depict side views of various apparatus embodiments of different shapes and sizes.

FIG. 5 depicts an exemplary foldable apparatus.

FIGS. 6A-C depict exemplary closure mechanism embodiments.

FIG. 7 depicts a number of exemplary positioning device configurations.

FIG. 8 illustrates various exemplary “hands free” embodiments.

FIG. 9 depicts various attachment angles between a base and a side member.

### DETAILED DESCRIPTION OF THE PREFERRED EMBODIMENT

Embodiments described herein generally are related to apparatus and methods for collecting animal waste. In particular, some embodiments are related to such apparatus and methods for the collection of waste from a dog. The apparatus are easy and convenient to use, and provide a more pleasant user experience than other apparatus that are currently available. The apparatus provide improved sanitation and prevent litter in the form of animal waste. Using the apparatus avoids messes on the ground and the necessity to scrape or to manipulate the animal droppings themselves. One need only touch the exterior of the apparatus.

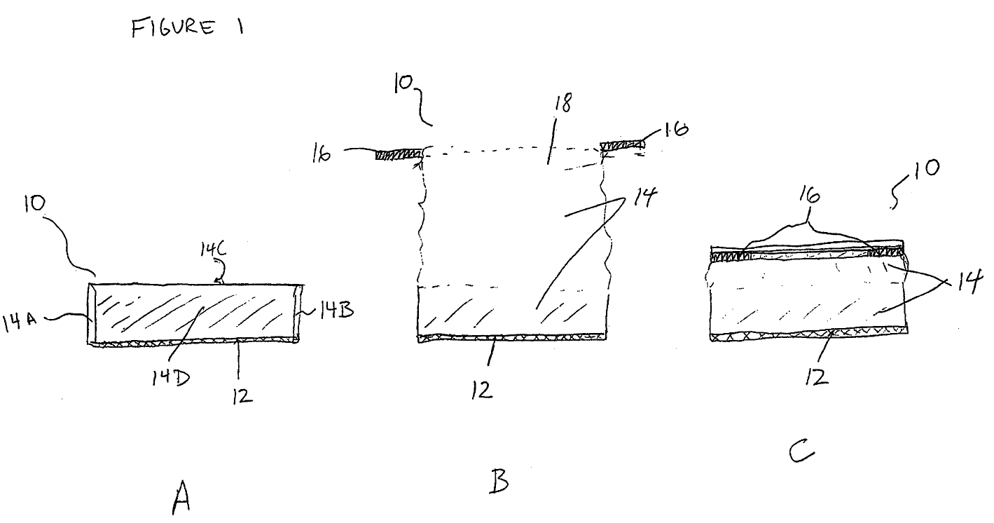

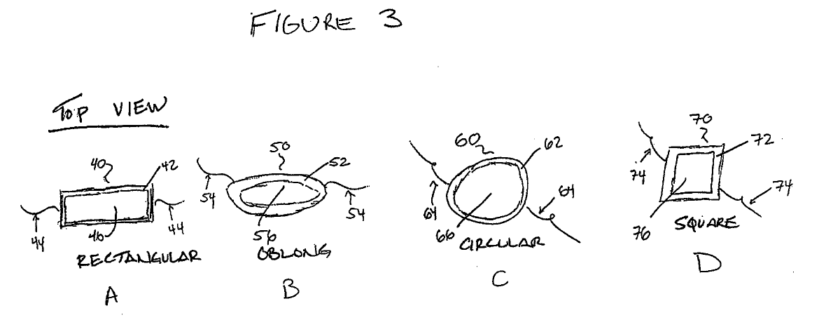

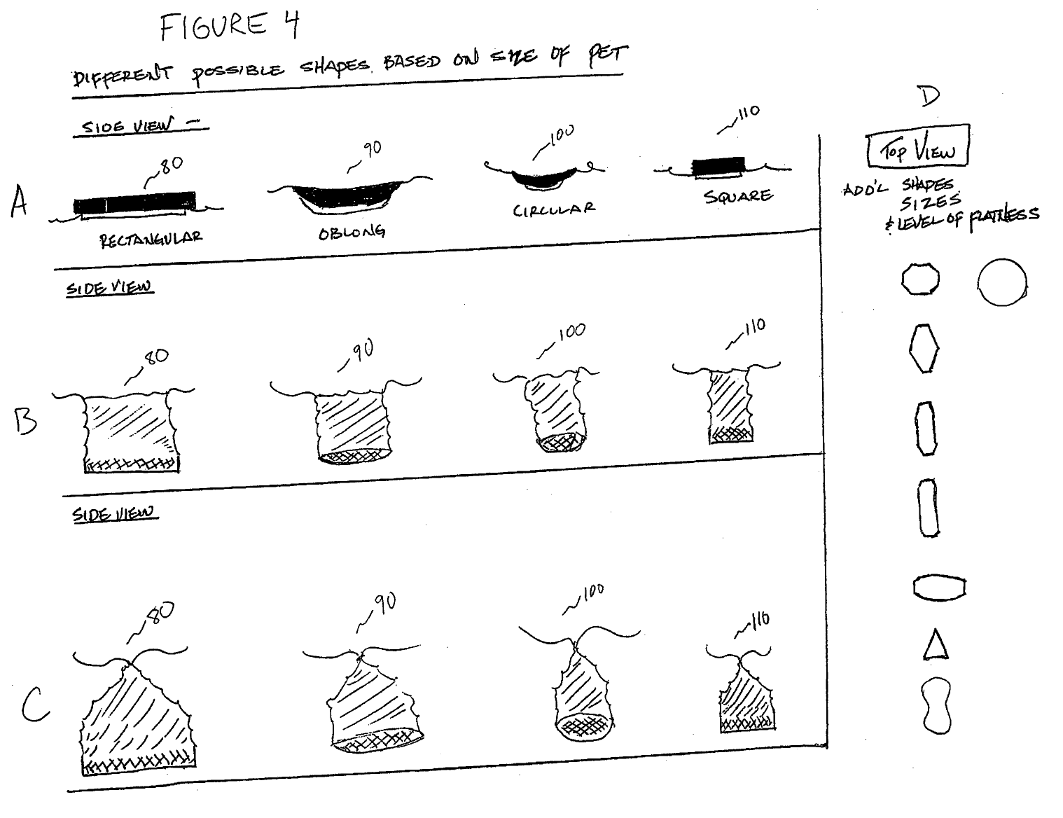

Some embodiments relate to apparatus for collecting or intercepting animal waste. FIG. 1 depicts one exemplary embodiment of the apparatus. Referring to FIG. 1A, the side view of a rectangular apparatus 10 is shown. The top opening is not shown. It should be noted that in alternative embodiments various other shapes can be used (see discussion of FIGS. 3-4, below). The apparatus 10 includes a base 12 and side members 14 (four side members 14A-D). Referring to FIG. 1A, the side members are shown in their un-extended or retracted position. As such the side members can be rolled down, folded down, retracted, or manipulated in any other manner so that the side members are retracted or not extended. As set forth more fully below, the animal waste can be deposited into the opening of the apparatus while it is in the un-extended configuration, as set forth in FIG. 1A, for example. It should be noted that the waste can be deposited while the side members are extended, as well.

FIG. 1B depicts an exemplary embodiment of the apparatus 10 with the side members 14 extended. For example, before or after deposit of the animal waste into the top opening of the non-extended apparatus 10, the side members 14 can be extended. The opening 18 of the apparatus with extended side members 14 is shown. The opening 18 can be closed using closure mechanism 16 (also referred to as closing member), which includes protruding members 20A and 20B. The exemplary closure mechanism 16 as shown is a paper covered wire. The exemplary sealing mechanism 16 can run across one half the length of the circumference of the apparatus 10, for example. In another non limiting example, the mechanism 16 can simply protrude with ends 20A and 20B.

FIG. 1C shows the apparatus 10 in a sealed configuration. After receipt of the animal waste, and after extending the side members 14, the opening 18 of the apparatus can be closed, for example, such that said side members 14 or sealed together to close the opening 18. In the case of the apparatus 10 shown in FIG. 1C, the opening 18 is pinched together, then folded down (for example, as is done with paper lunch bag). The apparatus side members can be folded down as much as desired, for example down to just above the level of the deposited animal waste. Once folded down to the appropriate level, the protruding members 20A and 20B are folded horizontally across the apparatus to hold the opening in a closed position.

One exemplary embodiment relates to a self-supporting enclosure apparatus adapted to receive animal waste. The self supporting enclosure can include, for example, a base having a periphery. As used in the embodiment, the terms “self-supporting” mean that the enclosure and base can stand on its own without the necessity of being attached or suspended from a pole, for example. The enclosure can further include one or more side members extending outward from said periphery of said base, and which also define an opening for receiving said animal waste, wherein said one or more side members are capable of motion between a retracted position having a shorter length, and an extended position having a greater length than when is said retracted position. In some embodiments, the enclosure also can include a closing member joined to said one or more side members, said closing member being adapted for sealing said one or more side members together to close said opening. In some aspects, the side members are integral with the base. In some aspects, the base and side members are formed from a bag.

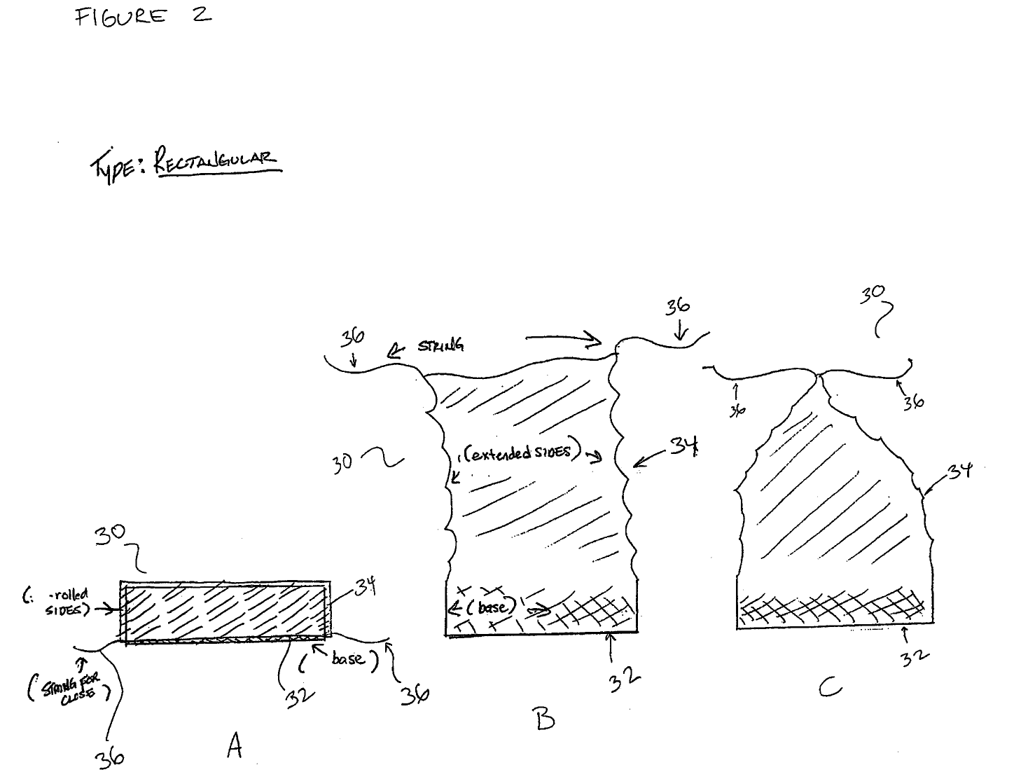

Another embodiment of the apparatus is depicted in FIG. 2. FIG. 2A shows an exemplary apparatus 30, having a base 32, side members 34, and closure strings 36 which encircle the periphery of the side members 34. The side members 34 can be extended, but as shown in FIG. 2A, the side members 34 are rolled, retracted, or compacted down in a non-extended position. The apparatus 30 can be obtained by the user in a condition as shown in FIG. 2A. The base can be any material as explained more fully below. As shown, the apparatus 30 is ready for use in that it simply needs to be positioned near the animal in order to receive the animal waste. Once the animal deposits its waste in the apparatus 30, the strings 36 are pulled in order to extend the side members 34 in a direction that is more or less perpendicular to the plane of the base 32. FIG. 2B shows the apparatus 30, having extended side members 34. Once extended, the closure strings 36 are pulled in order to close the opening of the apparatus, thereby sealing the deposited animal waste within the apparatus. FIG. 2C is a depiction of the exemplary apparatus 30 in a closed conformation. Use of the apparatus is explained more fully below.

FIG. 3 illustrates various exemplary apparatus embodiments A (40), B (50), C (60), and D (70) from a top view. Each illustrated apparatus respectively includes one or more side members (42, 52, 62, and 72), closure mechanisms shown as strings (44, 54, 64, and 74), and open areas for receiving the animal waste (46, 56, 66, and 76). It should be noted that many other shapes and combination of shapes can be used, and those depicted in FIGS. 3A-D are merely exemplary.

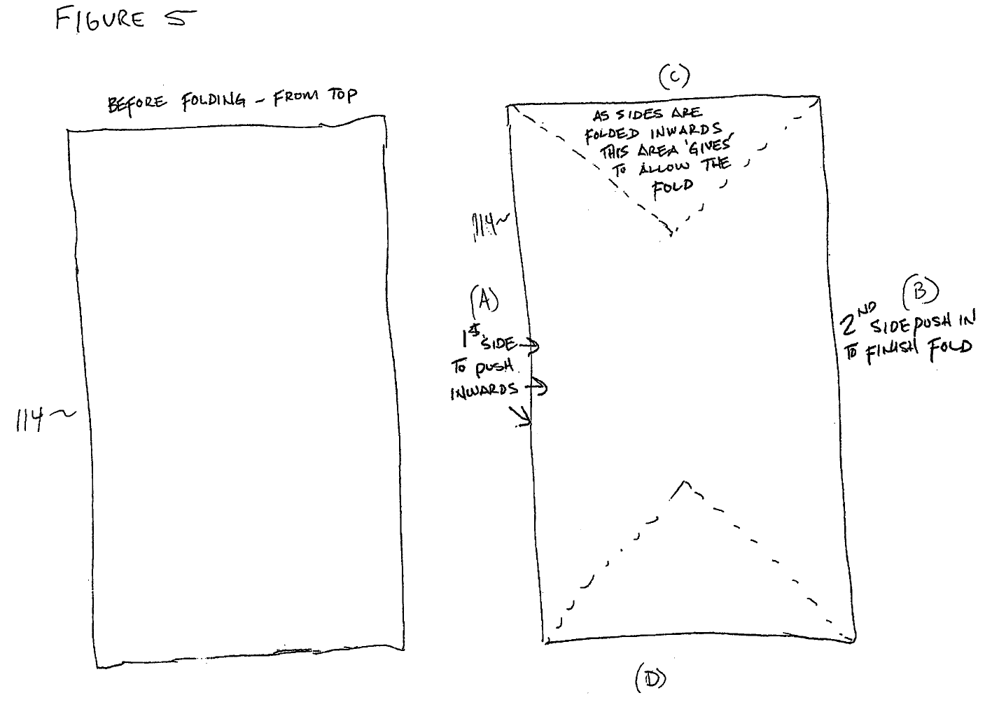

FIGS. 4A-D illustrate additional embodiments of the apparatus, particularly some of the various shapes and configurations that are possible. FIGS. 4A-C depicts side views of four exemplary apparatus 80, 90, 100, 110, each having a different shape. As shown in FIG. 4, the apparatus 80, 90, 100, 110 can be rectangular, oblong, circular, or square for example. Other shapes are contemplated as well. FIG. 4A shows each apparatus 80, 90, 100, 110 prior to extending the side members. The apparatus 80, 90, 100, 110 in such a conformation as shown in FIG. 4A can be of a size that is convenient for storage and for transporting with the user, for example in a purse or pocket. As set forth more fully below, the apparatus may be constructed of a material that permits bending or folding such that the apparatus can more easily fit into a pocket, for example. See the discussion of the FIG. 5 below. FIG. 4B shows each apparatus 80, 90, 100, 110 with extended side members. It should be noted that the apparatus 80, 90, 100, 110 can be positioned to receive the animal waste when configured as shown in either FIG. 4A or 4B. FIG. 4C shows the exemplary apparatus 80, 90, 100, 110 after being closed by the user. FIG. 4D illustrates from a top view some of the varied shapes for the apparatus. For example, the apparatus when viewed from the top can be, for example, octagonal (with sides of equal or unequal length), hexagonal (with sides of equal or unequal length), oval, circular, diamond shaped, square, rectangular, triangular, or the like.

As mentioned above, the apparatus may be constructed of a material that permits bending or folding such that the apparatus can more easily fit into a pocket or be more easily stored, for example. Referring to FIG. 5, an exemplary foldable apparatus 114 is shown from the top with the sides extend upward. The sides of apparatus 114 are folded down by pushing sides (A) and (B) inward. Sides (C) and (D) can be designed to give or collapse. The inward motion of sides (A) and (B) causes sides (C) and (D) to collapse such that the apparatus is completely flat.

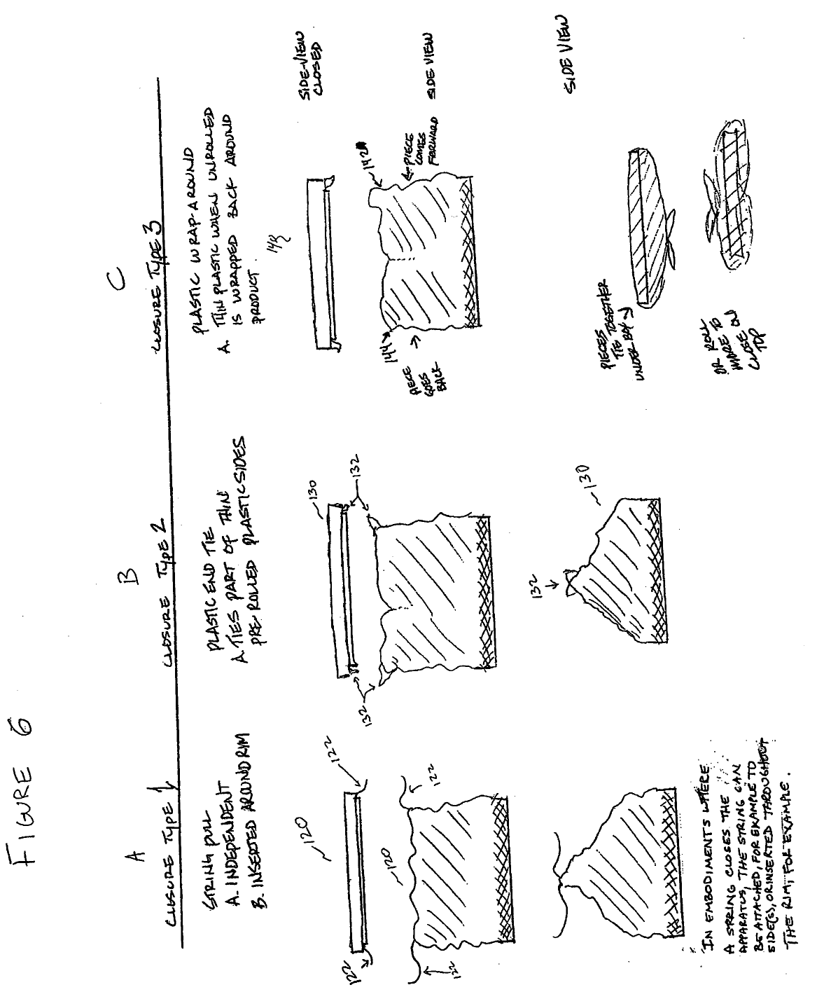

FIG. 6 illustrates embodiments of the apparatus with some additional closure mechanisms. Any mechanism can be used to close the opening of the apparatus after deposition of the animal waste. For example, the closure mechanism can be a twist tie, a paper covered wire, a string mechanism (for example, draw strings), tips or protrusions on the apparatus that permit tying, a zipping mechanism (plastic, metal, etc.), adhesive closure, wrap around tying mechanism, elastic elements, etc. Although several specific embodiments are shown in FIG. 6 and herein, it should be noted that many other closure mechanisms are contemplated. FIG. 6A illustrates an apparatus 120 with a draw string closure mechanism 122. The draw strings 122 can be provided with the apparatus inserted or sown into the periphery of the rim of the apparatus or the strings 122 simply may be provided independently, for example as part of the kit. In the case of the inserted strings, after receipt of the animal waste, the strings 122 are pulled to close the apparatus 120, and tied to maintain closure. In the case of a string that is provided independently, the top of the apparatus 120 is closed and the string 122 can be tied around a part of the closed apparatus 120. FIG. 6B illustrates an apparatus 130 with tie tips 132. When in the non-extended configuration, the tie tips 132 are accessible and can be grasped by the user in order to extend the apparatus 130. After receipt of the animal waste, the tie tips 132 are used to tie the apparatus 130 closed. FIG. 6C illustrates a third closure mechanism, referred to as the wrap around. After deposition of the animal waste, one part of the extended side member 142 is pulled forward, while the other part of the extended side member 144 is pulled back. The parts are designed to extend under the apparatus, where they are tied together in order to close the apparatus.

The apparatus can be made of various materials including papers, plastics, rubbers, polymers, and combinations thereof. Some preferred materials are thermoplastic elastomers and rubbers (TPE/TPR), Teflon® polymers, paper and other plastics, rubbers and polymers. In some embodiments the apparatus are constructed of an absorbent material, in others a water-proof material, while in still others a combination may be used of an absorbent interior material and a water proof exterior material, for example. In some embodiments the apparatus can be made in whole or in part of a flexible or elastic material, for example one that can be stretched or expanded. In some embodiments the apparatus can be stacked and easily stored due to their compact configuration.

In some embodiments the apparatus can be constructed of one material (including or excluding the closure mechanism). In other embodiments, the apparatus can have a base or portion of the base made of one material or density of the material, while the side members or portions thereof and other parts or portions thereof are made of a different material. For example the base can be comparatively more firm or thick, while the side members may be made of a thinner or more elastic material.

The base of the apparatus can have various configurations and geometries. In some embodiments, the base can be flat or planar, while in others the base may be tapered, concaved, pyramidal, etc. In some embodiments the base can be made of a material that can fold or bend without compromising the ability of the device to contain the animal waste. As set forth above, the base can be self-supporting, meaning that the base can stand on its own without the need to be attached or supported by a pole or the like, for example. As such the apparatus may be made more compact, for example, for easier portability. Preferably, the base is constructed of a material or designed in such away that it is relatively firm or able to support the weight of the deposited waste without collapsing or breaking.

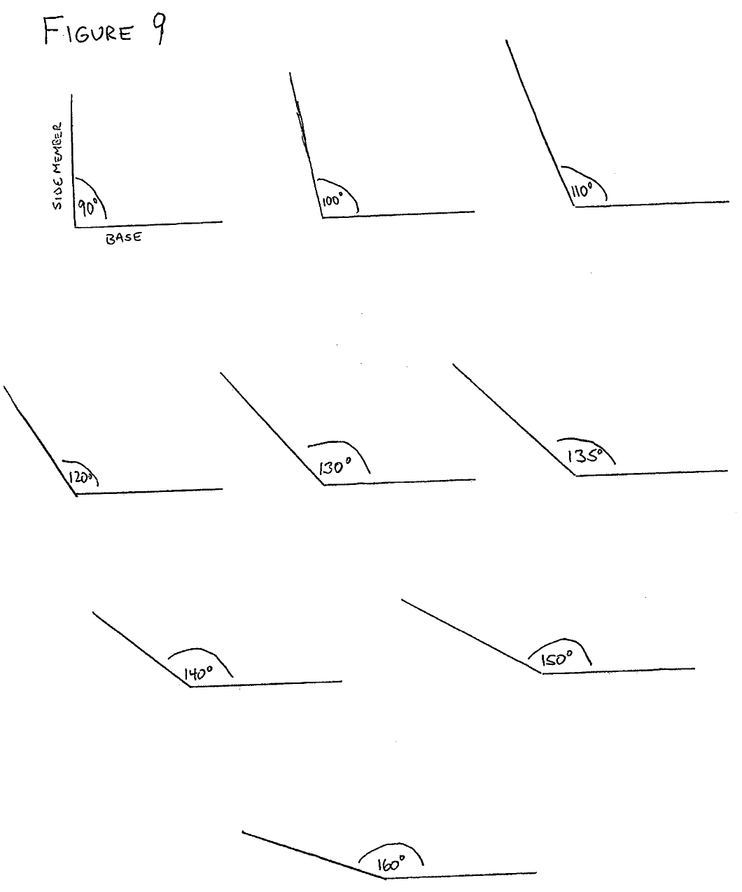

The side member(s) and base may be seamlessly connected or integral. The base and side(s) may be joined at a slope. The base and side(s) may be connected at an angle, for example perpendicular (90 degrees), or at more of an angle such that the top of the side members extend away from the base, thereby increasing the opening of the device. For example, the angle can be about 90, 93, 95, 98, 100, 103, 105, 108, 110, 115, 120, 125, 130, 135, 140, 150 or 160 degrees for example (See FIG. 9). Also, the side member(s) and the base can meet and form an arch or a round junction. As mentioned, in some embodiments, the apparatus may have side members that are retracted or compacted, for example, for easier storage, packaging, and/or portability. The apparatus or side(s) can be compacted or non-extended by rolling the side(s) down, folding the side members down, or simply compacting/pressing them down. Also, the side members can be designed in an “accordion” type of configuration so that the side members can be pressed down and later expanded.

The apparatus can be made in various sizes. Preferably the apparatus are of a size that generally “fits” the particular animal. A size that “generally fits” means that the apparatus will be of size that it can be placed in the appropriate location under or adjacent to the animal when the animal defecates. Preferably, the apparatus will be of a size that it will not touch the animal's legs or hind section. The apparatus can have different depth capacities or volume capacities, for example, according, to the typical quantity of waste for a particular animal. Smaller animals may have smaller surface areas and depths. Some animals may have narrower distances between rear legs, and yet have larger amounts of waste. Such animals may require an apparatus that is narrower, but with a greater depth. As another example large animals may need wider apparatus with larger volume capacities. As noted above, virtually any shape can be used. Some animals may be more comfortable with one shape, while others may find a different shape less intrusive or bothersome. Preferably, the shape is one that the particular animal is comfortable with. Exemplary shapes in two dimensions include square, rectangular, circular, hexagonal, octagonal, triangular, diamond, oval, and other symmetric and non-symmetric shapes.

The apparatus can be made in any color. Preferably, the apparatus are made in a color that is as unobtrusive or non-bothersome to the animal. Some animals may prefer darker colors, earth tones, or colors that match the geography where the animal may be when defecating. Other embodiments utilize other colors, including bright or fluorescent colors.

The apparatus can be scented. The apparatus can include an odor neutralizing/masking chemical. Further the apparatus can include absorbent materials or chemicals, for example, to prevent leakage or spills. Furthermore, the apparatus can come with a towel or wipe, which can, if desired, be attached to any part of the apparatus or come packaged with it as part of kit.

In some embodiments, the apparatus can be a portable and disposable dog waste receptacle. Such receptacles can have a firm base or a bottom dish, which can be made for example, from plastic, rubber, plastic mix, polyester mix, or other flexible or bendable material, or a stiff paper material. The base or bottom dish can also have attached to its periphery flexible ‘bag-like’ plastic side(s). The flexible side(s) can include a closing mechanism, for example, a standard cinch close bag (or tie-string, or thin plastic).

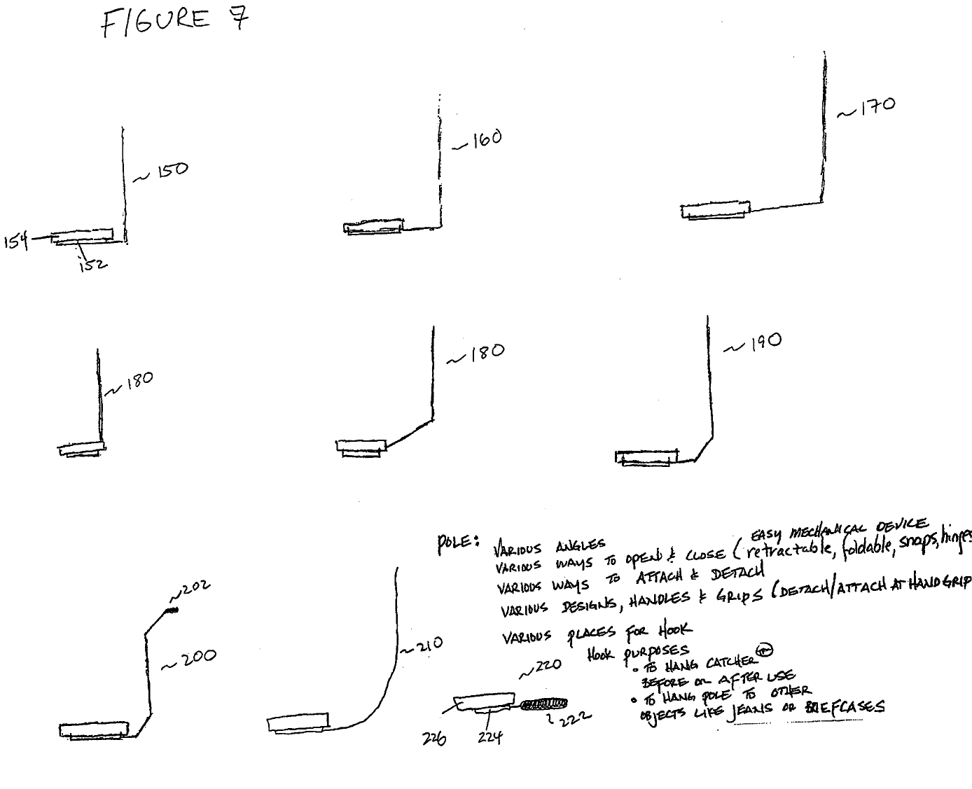

Some embodiments include the use of a positioning device, for example, a pole for assisting in positioning the apparatus under or adjacent to the animal. FIG. 7 depicts a number of exemplary device configurations 150, 160, 170, 180, 190, 200, 210, 220. The devices can be made of any suitable material, and have various lengths. Preferably, they have a length that permits the user to properly position the apparatus, while allowing the user to be in desired a position or distance. For example, a user may be in a chair, and in such case, preferably the pole device has a length to permit the user in the chair to comfortably position the apparatus under or adjacent to the animal. In other embodiments the positioning device can be much shorter or smaller, for example the length of a garden trowel (for example, device 220). Such shorter positioning devices can be used, for example, by users that prefer to not touch the apparatus that contains the waste, but do not want to use or transport a full length pole device.

The positioning devices can include a platform or other attachment/supporting means (for example, 152 or 224) for the apparatus (for example, 154 or 226). The apparatus can simply rest on a platform at the end of the positioning device or be supported in any other way. The apparatus can attach to the positioning device, slide over the pole, be attached by a hook, or any other method. The apparatus can be positioned, and then detached from the positioning device while the animal defecates, and then the apparatus can be re-attached to the positioning device, for example.

The positioning device can be retractable or telescoping, capable of folding, snapping together or disassembling, or can have hinges, for example. The positioning device can include a mechanism to permit storage or transport, for example a hook or other attachment device. For example, the device can hang from the user's clothing or attach to the user's bag. In some preferred embodiments, the positioning device (for example, pole) has a color that is less visible or noticeable by the animal. For example, the pole can be clear or can be of a color that matches or blends with the surroundings. The device can come with handles or grips 202, 222 to permit easy manipulation or grasping of the device by the user.

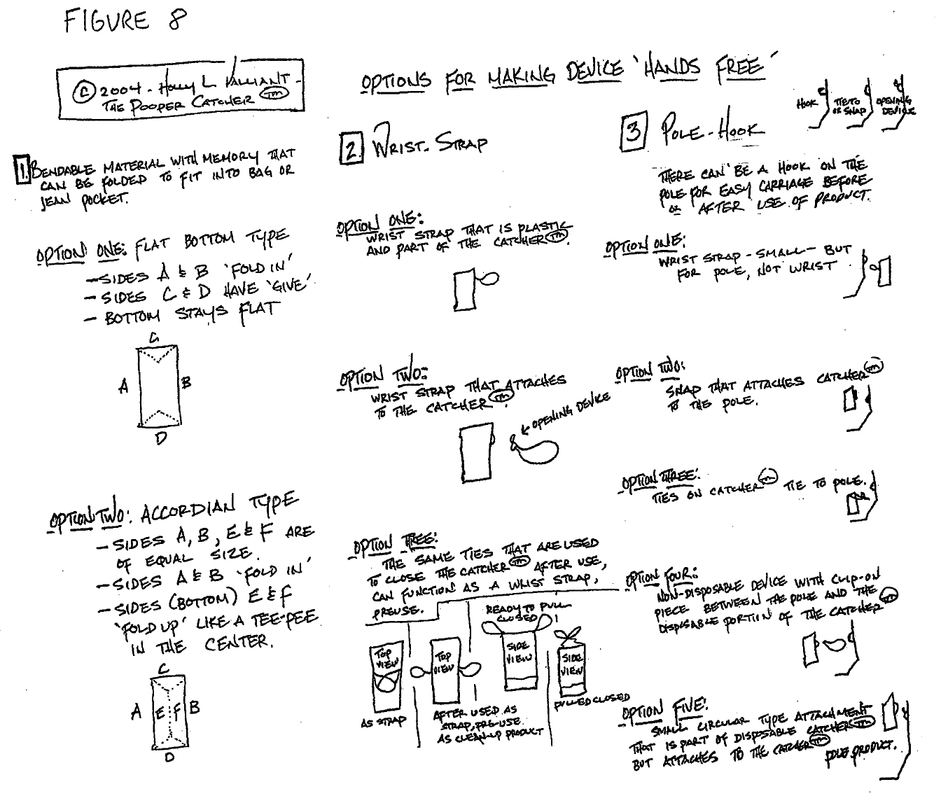

FIG. 8 illustrates various exemplary “hands free” embodiments. Such embodiments permit the user to contain intercept or obtain the animal waste without hand contact with the body of the apparatus. One exemplary option is the bendable or foldable apparatus, for example the “flat bottom” type and the “accordion” type. In these embodiments the apparatus sides extend, and the apparatus is closed, such that the user's hand does not have to contact the animal waste. The second type of option involves “wrist strap” alternatives. The apparatus can come with a loop or strap through which the user can insert his/her hand in order to carry the apparatus without contacting the body of the apparatus in which the animal waste is contained. The loop or strap can be permanently attached to the apparatus or it can be detachable, for example. Also, the same loops or ties that are used to close the apparatus can be used.

The third exemplary option involves a pole device or positioning device. The pole device or positioning device can include a hook or other attachment mechanism. The apparatus can include a small loop or other type of attachment opening that can attach to the pole device or positioning device. The apparatus and pole device or positioning device can be attached by means of a snap or other fixing mechanism (Velcro™, adhesive, etc.). A third alternative is to tie the apparatus to the pole device or positioning device. A fourth alternative is to have a non-disposable mechanism with a clip-on piece between the pole device or positioning device and the disposable portion of the apparatus.

The waste receipt apparatus can be made by hand, by semi-automated methods, or by automated methods. Depending upon the exact materials being used, the apparatus can be manufactured by any suitable method. The components can be made or obtained and affixed together by hand. The apparatus can be manufactured by machine processes including molding processes, injection molding processes, sealing and cutting machines, cut and glue processes, and the like.

The apparatus can be used to receive the waste of many animals, including dogs, cats, birds, reptiles, cows, horses, primates, and the like. Many animals signal via body language or posture that a bowel movement is imminent. When such a signal occurs, the user simply takes the apparatus in either the extended or non-extended configuration and positions the apparatus to “catch” or receive the waste from the animal before the waste contacts with the ground, for example. Once the waste is received, the apparatus side members can be extended (if not already done), and the apparatus can be closed using the appropriate closing mechanism. The closed apparatus can be discarded whenever desired.

Other embodiments relate to methods intercepting of collecting animal waste. Such methods can include the use of any apparatus according to the above-described embodiments. An exemplary method can include the steps of providing a self-supporting containment apparatus having a size that permits the containment apparatus to fit under the pet's hind section while the pet is defecating, and having a size sufficient to contain an entirety of waste released from said pet; positioning said containment apparatus under the hind section of said pet, such that the released pet waste is intercepted by said apparatus; and closing said containment apparatus.

As mentioned, the apparatus can be an apparatus according to the embodiments described herein. In some embodiments the apparatus used in the methods can include a base; one or more side members connected to said base at an angle (see FIG. 9 below); and a closing member connected to said one or more side members which is utilized as part of closing said containment apparatus. The angle can be, for example, about 90, 93, 95, 98, 100, 103, 105, 108, 110, 115, 120, 125, 130, 135, 140, 150 or 160 degrees. The side members can be in a retracted or extended position prior to defecation by the pet. Also, the side members can be put into an extended position after defecation by the pet. The positioning step can include supporting said containment apparatus when the pet is in the process of defecating. Even though the apparatus itself can be self-supporting, it should be noted that the apparatus still can be supported or positioned at an appropriate location to the pet. The supporting can include placing said apparatus on the ground. The supporting can include placing said apparatus between the ground and the hind portion of the pet. The pet can be a dog, for example.

The following non-limiting examples are meant to describe the preferred methods of the invention using certain preferred embodiments. Variations in the details of the particular methods employed and in the precise chemical compositions obtained will undoubtedly be appreciated by those of skill in the art.

### EXAMPLES

Example 1

### Collection of Waste from a Dog

An apparatus having a size that permits position of the apparatus beneath the hind end of the dog was used. With the apparatus in the open position the apparatus was placed on the ground beneath the dog's hind quarters before it defecated.

Generally, every dog, when it defecates, has a distinctive swatting/signal behavior. This provides an opportunity to place the device beneath the dog as indicated.

After use, the cinch string or tie-string technology was used to pull the pre-rolled thin baggy-type side members first to the open position, and then pulled closed to entrap the dog waste within the receptacle. The product, and its contents, then were easily taken and discarded. It should be noted that the apparatus can be used to collect waste from animal as requested by a veterinarian, for example, if a sample is needed.

The invention illustratively described herein suitably may be practiced in the absence of any element or elements, limitation or limitations which is not specifically disclosed herein. The terms and expressions which have been employed are used as terms of description and not of limitation, and there is no intention that in the use of such terms and expressions indicates the exclusion of equivalents of the features shown and described or portions thereof. It is recognized that various modifications are possible within the scope of the invention. Thus, it should be understood that although the present invention has been specifically disclosed by preferred embodiments and optional features, modification and variation of the concepts herein disclosed may be resorted to by those skilled in the art, and that such modifications and variations are considered to be falling within the scope of the invention.

What is claimed is:

1. A method of intercepting pet waste, comprising
providing a self-supporting containment apparatus having a size that permits the containment apparatus to fit under the pet's hind section while the pet is defecating, and having a size sufficient to contain an entirety of waste released from said pet;
positioning said containment apparatus under the hind section of said pet, such that the released pet waste is intercepted by said apparatus; and
closing said containment apparatus.

2. The method of claim 1, wherein said containment apparatus comprises:
a base;
one or more side members connected to said base at an angle; and
a closing member connected to said one or more side members which is utilized as part of closing said containment apparatus.

3. The method of claim 2, wherein said angle is selected from the group consisting of about 90, 100, 110, 120, 130, 135, 140, and 150 degrees.

4. The method of claim 2, wherein said side members are in a retracted position prior to defecation by the pet.

5. The method of claim 2, wherein said side members are in an extended position prior to defecation by the pet.

6. The method of claim 2, wherein said side members are in an extended position after defecation by the pet.

7. The method of claim 1, wherein said positioning step comprises supporting said containment apparatus when the pet is in the process of defecating.

8. The method of claim 7, wherein said supporting comprises placing said apparatus on the ground.

9. The method of claim 7, wherein said supporting comprises placing said apparatus between the ground and the hind portion of the pet.

10. The method of claim 1, wherein the pet is a dog.

11. A pet waste containment apparatus, comprising:
a base;
one or more side members connected to said base at an angle of at least about 90 degrees to not more than about 150 degrees; and
a closing member.

12. The apparatus of claim 11, wherein said side members have a height sufficient to prevent spillage of pet waste.

13. The apparatus of claim 11, wherein said base and one or more side members comprise a water resistant material.

14. The apparatus of claim 13, wherein said base and one or more side members further comprise an absorbent material on the interior of said apparatus.

15. An apparatus for intercepting animal waste, comprising:
a self-supporting enclosure adapted for receiving animal waste, said self-supporting
comprising:
a base having a periphery;
one or more side members extending outward from said periphery of said base and defining an opening for receiving said animal waste, said one or more side members being capable of motion between a retracted position having a shorter length and an extended position having a greater length than said retracted position; and
a closing member joined to said one or more side members, said closing member being adapted for sealing said one or more side members together to close said opening.

16. The apparatus of claim 15, wherein said one or more side members are integral with said base.

17. The apparatus of claim 16, wherein said base and side members are formed from a bag.
